(19) United States
(12) Patent Application Publication
(10) Pub. No.: US 2010/0265092 A1
(43) Pub. Date: Oct. 21, 2010

(54) METHOD FOR DETERMINING LOCATION USING ACCESS POINT, AND APPARATUS THEREOF

(76) Inventors: Byung Doo Kim, Daejeon (KR); Seong Yun Cho, Daejeon (KR); Young Su Cho, Seoul (KR); Wan Sik Choi, Daejeon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/741,935

(22) PCT Filed: Aug. 20, 2008
(86) PCT No.: PCT/KR2008/004860

§ 371 Date: May 7, 2010

(30) Foreign Application Priority Data
Nov. 28, 2007 (KR) 10-2007-0121849

(51) Int. Cl. G08B 5/22

(52) U.S. Cl. 340/825.49

(57) ABSTRACT

The present invention relates to a location measuring method using an access point, and an apparatus using the same. According to the present invention, a location of a terminal is estimated by using a signal strength received from an access point installed at a known position in a wireless network, and location of the access point installed at an unknown position is estimated by using a signal strength received from the access point installed in the unknown position and estimated location information of the terminal. In addition, a location of the terminal is finally calculated by using estimated location information of the access point installed at the known position. As described, the location of the terminal is determined by using estimated location information of an AP that is randomly installed by a user (that is, installed at an unknown position), and therefore a location of an AP installed in an area where it is difficult to measure and availability of location measurement can be improved. In addition, a signal strength measurement value, estimation location information of an AP installed at a known position, and estimation location information of an AP installed at an unknown position are used for location information calculation of a terminal, and accordingly, accuracy of the location measure can be improved.

### TECHNICAL FIELD

The present invention relates to a method for determining location using an access point, and an apparatus using the method. Particularly, it relates to a method for calculating location information of a terminal by using a received signal strength intensity value transmitted from an access point (AP).

The present invention was supported by IT R&D MIC/IITA [2007-F-040-01, Development of Indoor/Outdoor Seamless Positioning Technology].

### BACKGROUND ART

Recently, the need for location information has significantly increased. Accordingly, methods for providing location information by using a wireless local area network (wireless LAN) and an ultra wide-band (UWB) have been studied.

Location determining methods using a wireless network include a time of arrival (TOA) method, a time difference of arrival (TDOA), an angle of arrival (AOA), and a received signal strength intensity (RSSI) method using at least one received signal strength intensity value.

The location determining method using the RSSI method has an advantage of using wireless communication infrastructure that is currently provided since it does not require time synchronization, and therefore various studies related thereto have been conducted.

A conventional location determining method using the RSSI method requires location of an access point (AP). Therefore, AP information cannot be used in an area where a user randomly installs an AP such that positioning is difficult. Accordingly, location determining is limited to areas where an AP install location is known.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a location measuring method using an access point, which has advantages of improving availability and accuracy in location measurement, and an apparatus using the same.

### Technical Solution

An exemplary location measuring method according to an embodiment of the present invention measures a location of a first access point (AP) installed at an unknown position and a location of a second AP installed at a known position by using a terminal that accesses the first and second APs.

The location measuring method includes receiving at least one first received signal strength intensity value for the first AP, estimating location information of the terminal by receiving at least one second received signal strength intensity value for the second AP, and determining a location of the first AP by using matching information when the number of matching information having the at least one first received signal strength intensity value and the location information of the terminal is greater than a predetermined reference number.

Another exemplary location measuring method according to an embodiment of the present invention includes receiving a first received signal strength intensity value from a terminal that has requested location measurement, the first received signal strength intensity value being for a first access point (AP) installed at an unknown position, checking location information of the first AP, the location information being determined by using location information of the terminal that is estimated by using a second receive signal strength intensity value for a second AP and location information of the second AP, and calculating weights for the location information of the first AP, the signal strength value being received from the terminal that has requested the location measurement, and an estimated location information error of the first AP, and determining a location of the terminal that has requested the location measurement through a weighted least squares method using the weights.

An exemplary apparatus according to an embodiment of the present invention measures a location of a terminal by using a signal strength value that is received from an AP in a wireless network. The apparatus includes an AP location estimator estimating a location of a first AP by using matching information when the number of matching information is greater than a predetermined reference number, the matching information including location information of the terminal that is estimated by using at least one first received signal strength intensity value of a first access point (AP) installed at an unknown position and at least one second received signal strength intensity value received from a second AP installed at a known position, the first and second received signal strength intensity values being received from the terminal, and a terminal location calculator calculating weights of the first received signal strength intensity value of the first AP, location information of the first AP, and an estimated location error of the first AP, and determining a location of the terminal that has requested location measurement by using a weighted least squares method when receiving the first received signal strength intensity value from the terminal, the location information of the first AP being estimated by the AP location estimator.

### ADVANTAGEOUS EFFECTS

As described, according to the present invention, the location of the terminal is determined by using location estimation information of an AP that is randomly installed by a user (that is, installed at an unknown position), and therefore location of an AP that is installed at an area where it is difficult to measure and availability of location measurement is improved.

In addition, received signal strength intensity values, the location information of an AP installed at a known position, and location estimation information of an AP installed at an unknown position are used for location information calculation of a terminal, and accordingly, accuracy of the location measurement is improved.

### BRIEF DESCRIPTION OF THE DRAWINGS

FIG. 1 is a schematic diagram of a wireless network for location determination, and the wireless network includes an access point (AP) installed at an unknown position and an AP installed at a known position.

FIG. 2 is a detailed block diagram of a location measuring apparatus according to an exemplary embodiment of the present invention.

FIG. 3 is a flowchart of a location determining method using an AP installed at an unknown position location according to the exemplary embodiment of the present invention.

FIG. 4 is a detailed flowchart of a location determining method using an AP installed at an unknown position according to the exemplary embodiment of the present invention.

FIG. 5 is a graph for comparing a distance error according to the exemplary embodiment of the present invention and a distance error according to a conventional method.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “unit”, “-er (-or)”, and “module” used herein mean a unit that processes at least one function or operation. This can be implemented by hardware, software, or a combination thereof.

A location determining method using an access point (AP) and an apparatus using the same according to an exemplary embodiment of the present invention will be described with reference to the drawings.

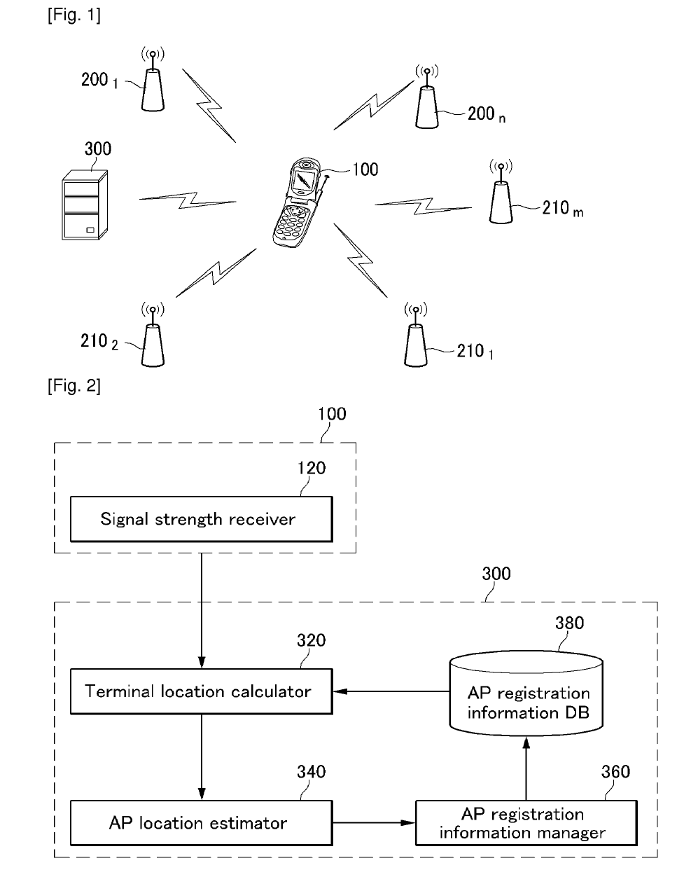

FIG. 1 shows a schematic diagram of a wireless network for determining a location. In FIG. 1, the wireless network includes a first AP installed at an unknown position and a second AP installed at a known position.

As shown in FIG. 1, the wireless network for location measurement includes a terminal 100, two or more APs 200₁ to 200ₘ that are installed at known positions, at least one AP 210₁ to 210ₘ that is installed at an unknown position, and a location measuring apparatus 300.

The terminal 100 receives received signal strength intensity values that is transmitted from the two or more APs 200₁ to 200ₙ installedat known positions and the at least one AP 210₁ to 210ₘ installed at an unknown position. The terminal 100 transmits the received signal strength intensity values to the location measuring apparatus 300.

The APs 200₁ to 200ₙ and 210₁ to 210ₘ include the unknown APs 210₁ to 210ₘ installed at unknown positions and the known APs 200₁ to 200ₙ installed at known positions. At this time, location information of the known APs is registered to the location measuring apparatus 300. Hereinafter, the unknown APs will be referred to as first APs and the known APs will be referred to as second APs for convenience in description. Herein, the first APs 210₁ to 210ₘ are randomly installed by a user so that their install positions are not known since location information of the APs 210₁-210ₘ they are not registered to the location measuring apparatus 300.

The location measuring apparatus 300 determines a location of the terminal 100 by using received signal strength intensity values of signals received from more than two of the second APs 200₁ to 200ₙ and at least one of the first APs 210₁ to 210ₘ. Conventionally, only the received signal strength intensity values of the second AP 200₁ to 200ₙ are used, but the received signal strength intensity values of the first AP 210₁ to 210ₘ as well as the second AP 200₁ to 200ₙ is also used in the exemplary embodiment of the present invention. A configuration of the location measuring apparatus 300 will be described with reference to FIG. 2.

FIG. 2 is a detailed block diagram of the location measuring apparatus according to the exemplary embodiment of the present invention.

As shown in FIG. 2, the terminal 100 includes a signal strength receiver 120. The signal strength receiver 120 receives a received signal strength intensity value from at least one of the first APs 210₁ to 210ₘ and the second APs 200₁ to 200ₙ. The received signal strength intensity values from the terminal 100 is transmitted to the location measuring apparatus 300 for calculating a location of the terminal 100.

The location measuring apparatus 300 includes a terminal location calculator 320, an AP location estimator 340, an AP registration information manager 360, and an AP registration information database 380.

The terminal location calculator 320 determines whether the AP transmitted the received signal strength intensity value is one of the first APs 210₁ to 210ₘ or one of the second APs 200₁ to 200ₙ.

The terminal location calculator 320 estimates a location of the terminal 100 by using a received signal strength d intensity value of at least one second AP 200₁ to 200ₙ to generate location information of the terminal 100. At this time, the terminal location calculator 320 transmits the location information of the terminal 100 to the AP location estimator 340.

In addition, the terminal location calculator 320 calculates a weight by using a location estimation error of the first AP 210₁ to 210ₘ and calculates the final location of the terminal 100 by using the weight when the received signal strength intensity value received from the terminal 100 includes in received signal strength intensity values of the first AP 210₁ to 210ₘ that are registered to the AP registration information database 380.

The AP location estimator 340 estimates the location of the first AP 210₁ to 210ₘ by using the location information of the terminal 100 that is transmitted from the terminal location calculator 320 and the received signal strength intensity value of the first AP 210₁ to 210ₘ, to generate location estimation information of the first AP 210₁ to 210ₘ.

The AP registration information manager 360 stores a unique identification (ID) numbers and the location estimation information of the corresponding first AP 210₁ to 210ₘ in the AP registration information database 380 if a covariance of the location estimation error of the location estimation information of the first AP 210₁ to 210ₘ that has been calculated by the AP location estimator 340 is smaller than a threshold value.

While not shown in the drawing, the AP registration information database 380 includes both an AP registration information database (DB) and a matching information DB.

The AP registration information DB stores AP registration information that includes a unique ID number and location estimation information of each of the first APs 210₁ to 210ₘ and location information of each of the second APs 200₁ to 200ₙ.

The matching information DB stores by matching the location information of the terminal 100 received from the terminal location calculator 320, a unique ID number of the first AP 210₁ to 210ₘ, and the received signal strength intensity value corresponding to the first AP 210₁ to 210ₘ, that is, by corresponding to each other, to generate matching information.

A location measuring method based on the configuration diagrams shown in FIG. 1 and FIG. 2 will now be described in further detail.

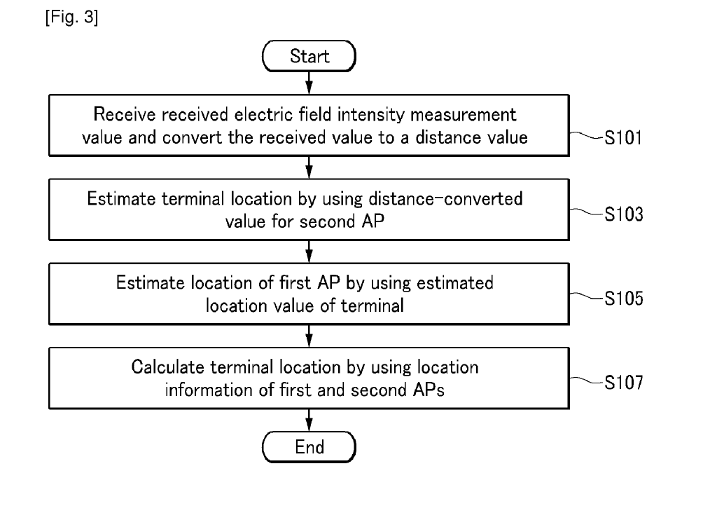

FIG. 3 is a flowchart of a location measure method using an unknown AP according to an exemplary embodiment of the present invention.

As shown in FIG. 3, the terminal location calculator 320 of the location measuring apparatus 300 receives received signal strength intensity values of the APs 200₁ to 200ₙ, and AP 210₁ to 210ₘ received at the terminal 100 and converts the received signal strength intensity value to a distance measurement value (S101). At this time, the terminal location calculator 320 determines whether a received signal strength intensity value of the first AP 210₁ to 210ₘ is included in the received signal strength intensity values from the terminal 100.

Then, the terminal location calculator 320 measures a location of the terminal 100 by using the distance value of the second AP 200₁ to 200ₙ, to generate location information with respect to the location of the terminal 100 (S103).

The AP location estimator 340 estimates a location of the first AP 210₁ to 210ₘ by using the location Information of the terminal 100 measured in the step S103 and the distance value of the first AP 210₁ to 210ₘ converted in the step S101 (S105) to generate location estimation information of the first AP 210₁ to 210ₘ.

The terminal location calculator 320 calculates the final location of the terminal 100 by using the location estimation information of the first AP 210₁ to 210ₘ in the step S105 and the location information of the second APs 200₁ to 200ₙ, stored in the AP registration information DB 380 (S107).

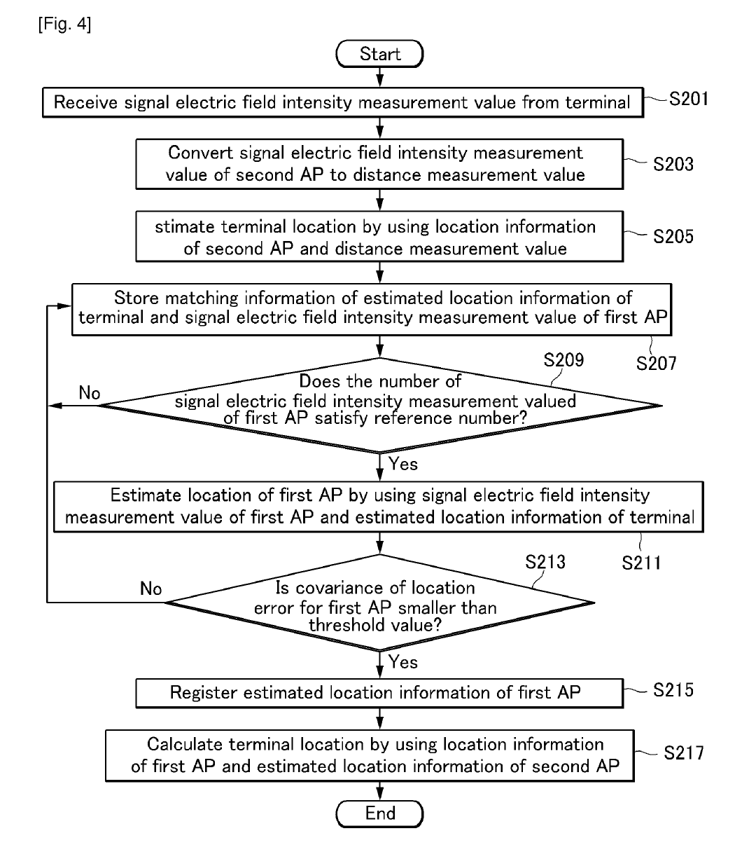

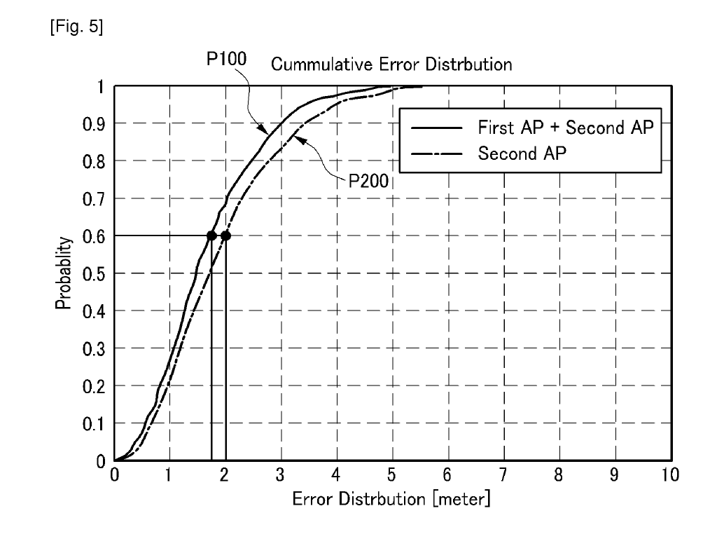

FIG. 4 is a detailed flowchart of the location measuring method using the first APs 210₁ to 210ₘ and the second APs 200₁ to 200ₙ, according to the exemplary embodiment of the present invention, and is more detailed than the flowchart of FIG. 3.

As shown in FIG. 4, the terminal location calculator 320 of the location measuring apparatus 300 receives at least one received signal strength intensity value of at least one AP measured by the terminal 100 (S201). Here, the terminal location calculator 320 classifies the received signal strength intensity value into a value for at least one of the first APs 210₁ to 210ₘ that a user has randomly installed and a value for at least one for the second APs 200₁ to 200ₙ, that is installed in a known position.

The terminal location calculator 320 converts the received signal strength intensity value of the second AP 200₁ to 200ₙ, received in the step S201 to a distance measurement value (S203). In this instance, the received signal strength intensity measurement value can be converted to the distance value by using an attenuation model of a signal strength with respect to a distance between the second AP 200₁ to 200ₙ and the terminal 100.

The following Equation may be used for conversion of the received signal strength intensity value to the distance measurement value. Math Figure 1 represents a signal strength loss in 802.11.

$${L}_{fsl} = 16 {d}^{2} \frac{{π}^{2}}{{λ}^{2}} \qquad [ Equation 1 ]$$

Here, L_{fsl} denotes a signal strength loss in free space, d denotes a distance between an AP and a terminal, and λ denotes a frequency length.

A signal strength loss of 802.11 b/g AP using about 2.45GHz frequency bandwidth may be briefly represented as given in Equation 2.

L_{fsl}=40+20·log₁₀(d) [Equation 2]

In addition, a signal strength loss in consideration of attenuation and scattering can be represented as given in Equation 3.

L=40 +10·l·log₁₀(d)+Lₛ [Equation 3]

Here, a path loss exponent l is changed in accordance with a type of an obstacle between the AP and the terminal. If there if a line of sight (LOS), l=2, and the path loss exponent l has a value between about 2 and about 4 if there is an obstacle. Lₛ implies a loss due to the number of walls or floors and an attenuation characteristic of a medium thereof.

The terminal location calculator 320 estimates the location of the terminal 100 by using the distance measurement value converted in the step S203 and the location information of the second AP 200₁ to 200ₙ to generate location information of the terminal 100 (S205). The location information of the second AP 200₁ to 200ₙ is stored in the AP registration information DB 380.

In this instance, the location of the terminal 100 may be estimated by using a least squares method. For location estimation by using the least squares method, the following Equation can be used.

First, a distance between the i-th AP located at rᵢ=(xᵢ,yᵢ) and a terminal located at rᵤ=(xᵤ,yᵤ) can be represented as given in Equation

dᵢ=|rᵢ−rᵤ|=\sqrt{(xᵢ−xᵤ)²+(yᵢ−yᵤ)²} [Equation 4]

If a random-estimated location of the terminal is (\hat{x}ᵤ,ŷᵤ), a distance between the AP and the terminal can be estimated as given in Equation 5.

\hat{d}ᵢ=|rᵢ−\hat{r}ᵤ|=\sqrt{(xᵢ−\hat{x}ᵤ)²+(yᵢ−ŷᵤ)²} [Equation 5]

When a difference between the distance between the estimated location of the terminal and the i-th AP and a distance measurement value is Δ\hat{d}ᵢ, (\hat{x}ᵤ,ŷᵤ) can be expressed by using Taylor expansion.

$$Δ {d}_{i} = - \frac{{r}_{i} - {\hat{r}}_{u}}{\vert {r}_{i} - {\hat{r}}_{u} \vert} Δ r + Δɛ \qquad [ Equation 6 ]$$

Equation 7 can be obtained by applying the same process to n APs.

$$Δ d = H Δ r + Δɛ \\ Here , \\ Δ d = {[ \begin{matrix}Δ {d}_{1} & Δ {d}_{2} & ⋯ & Δ {d}_{n}\end{matrix} ]}^{T} \\ H = {[ \begin{matrix}- \frac{{r}_{1} - {\hat{r}}_{u}}{\vert {r}_{1} - {\hat{r}}_{u} \vert} & - \frac{{r}_{2} - {\hat{r}}_{u}}{\vert {r}_{2} - {\hat{r}}_{u} \vert} & ⋯ & - \frac{{r}_{n} - {\hat{r}}_{u}}{\vert {r}_{n} - {\hat{r}}_{u} \vert}\end{matrix} ]}^{T} \\ Δɛ = {[ \begin{matrix}{Δɛ}_{1} & {Δɛ}_{2} & ⋯ & {Δɛ}_{n}\end{matrix} ]}^{T} \qquad [ Equation 7 ]$$

If it is assumed that an average of Δε is 0, a location estimation error Δr=rᵤ−\hat{r}ᵤ can be obtained by using the least squares method as given in Equation 8.

Δ\hat{r}=(H^{T} H)⁻¹ H^{T} Δd [Equation 8]

Therefore, an estimated location of the terminal may be finally obtained as given in Equation 9.

rᵤ=\hat{r}ᵤ+Δ\hat{r} [Equation 9]

Then, the AP registration information manager 360 matches the location estimation information of the terminal 100 estimated in the step S205, the unique ID number and the received signal strength intensity value of the first AP 210₁ to 210ₘ received in the step 201 to store as matching information (S207).

The AP location estimator 340 estimates a location of the first AP 210₁ to 210ₘ when received signal strength intensity values measured at a plurality of locations with respect to one of the first APs 210₁ to 210ₘ are received.

In this instance, the AP location estimator 340 s determines whether the number of the received signal strength intensity values of the first APs 210₁ to 210ₘ satisfies a reference value for estimating the location of the first AP (S209).

If a result of the determination of the step S209 does not satisfy the reference value, the process returns to the step S207.

If the result of the determination of the step S209 satisfies the reference value, the AP location estimator 340 estimates the location of the first AP 210₁ to 210ₘ by using the location information of the terminal 100 and the received signal strength intensity values of the first AP 210₁ to 210ₘ of the matching information that is stored in the step S207 (S211), to generate location estimation information of the location of the first AP 210₁ to 210ₘ.

In this instance, received signal strength intensity values of one of the first APs 210₁ to 210ₘ may be measured at a plurality of locations by using one terminal 100 or may be simultaneously measured by using a plurality of terminals 100.

In order to estimate the location of the first APs 210₁ to 210ₘ by using one terminal 100, more than two independent location information and received signal strength intensity values with respect to the terminal 100 should be acquired.

A received signal strength intensity value for the first AP 210₁ to 210ₘ at time k can be converted to a distance measurement value by using an attenuation model of the signal strength as given in Equation 10.

dₖ=\sqrt{(x− x̅ₖ)²=(y− y̅ₖ)²}+wₖ [Equation 10]

Here, (x,y) denotes location estimation information of the first AP 210₁ to 210ₘ, and ( x̅ₖ, y̅ₖ) denotes location information of the terminal 100 calculated by using the first AP 210₁ to 210ₘ. wₖ denotes an estimated location error between the first AP 210₁ to 210ₘ and the terminal 100 due to noises of a received signal strength intensity value of the first AP 210₁ to 210ₘ.

When location information of the terminal 100 that is independently obtained from N time points and distance measurement values of the first APs 210₁ to 210ₘ are used, the location of the first APs 210₁ to 210ₘ can be respectively estimated by using Equation 5 to Equation 9.

In addition, in the AP location estimator 340, a covariance of the location estimation error for the location of the first AP 210₁ to 210ₘ calculated by using the least squares method can be represented as given in Equation 11.

P=(H^{T} R⁻¹ H)⁻¹ [Equation 11]

Here, R denotes an error covariance of a distance−measurement value. When the location of the terminal 100 is calculated by using the distance measurement values of the first AP 210₁ to 210ₘ, a weighted least squares (WLS) method is used for considering uncertainty for the location estimation information of the first AP 210₁ to 210ₘ, and a matrix of Equation 11 is used for calculating a weight value.

In order to estimate the location of the first AP 210₁ to 210ₘ by using more than two terminals 100, Equation 12 can be used.

A distance measurement value between the first AP 210₁ to 210ₘ measured by the i-th terminal at k time point and the terminal 100 can be calculated as given in Equation 12.

d_{i,k}=\sqrt{(x− x̅_{i,k})²+(y− y̅_{i,k})²}+w_{i,k} [Equation 12]

When n independent distance measurement values are obtained by using i terminals, the location of the first AP 210₁ to 210ₘ can be calculated by using Equation 5 to Equation 9, and a location estimation error for the locations of the first APs 210₁ to 210ₘ can be calculated by using Equation 11.

In order to consider uncertainty for the location estimation information of the first AP 210₁ to 210ₘ, the location of the terminal 100 can be calculated by using the WLS method.

A diagonal term of a weight value matrix can be set as given in Equation 13.

$${g}_{i} = \{ \begin{matrix}1 & KAP \\ 1 - {σ}_{d , i} / {d}_{i} & UAP\end{matrix} \qquad [ Equation 13 ]$$

Where gᵢ denotes a weight value of the i-th AP, and dᵢ denotes a distance measurement value between the i-th AP and the terminal. When the i-th AP is one of the first APs 210₁ to 210ₘ, σ_{d,i} that denotes a standard deviation for the calculated location estimation error for the first AP 210₁ to 210ₘ can be calculated from the matrix of Equation 11.

σ_{d,i}=\sqrt{P(1,1)+P(2,2)}=\sqrt{σₓ²+σ_{y}²} [Equation 14]

In addition, a solution of the least squares method using the weight value matrix can be calculated as given in Equation 15, with inclusion of the weight value matrix.

Δr=(H^{T} W⁻¹ H)⁻¹ H^{T} W⁻¹ Δd [Equation 15]

Here, W denotes a predetermined weight value matrix set by using Equation 13.

Next, the AP location estimator 340 determines whether the covariance with respect to a location estimation error of the location estimation information for the first AP 210₁ to 210ₘ estimated in the step S211 is smaller than a predetermined threshold value (S213).

If it is determined in the step S213 that the covariance is not smaller than the predetermined threshold value, the AP location estimator 340 returns to the step S207.

If it is determined in the step of S213 that the covariance is smaller than the predetermined threshold value, the AP location estimator 340 registers the estimation information of the first AP estimated in the step S211 to the AP registration information (S215).

Then, the terminal location calculator 320 calculates the final location of the terminal 100 by using the location information of the second AP 200₁ to 200ₙ and the location estimated information of the first AP 210₁ to 210ₘ that is registered in the step S215 (S217). Here, the final location calculation of the terminal 100 performed by using Equation 15 as in the step S205.

FIG. 5 is a graph for comparing a distance error according to the exemplary embodiment of the present invention with a distance error according to a conventional location estimation method.

As shown in FIG. 5, the graph shows a cumulative error distribution P100 for a distance error in the case of positioning a location by applying the first APs 210₁ to 210ₘ as well as the second APs 200₁ to 200ₘ and a cumulative error distribution P200 for a distance error in the case of determining a location by using only the second APs 200₁ to 200ₙ.

In this graph, for location measurement accuracy with a probability of about 60% (0.6), the distance error is about 1.8 in the case P100 that both of the first and second APs 210₁ to 210ₘ and 200₁ to 200ₙ are used. However, the distance error is about 2 in the case of P200 that only the second APs 200₁ to 200ₙ are used.

Accordingly, since the distance error decreases, the location measure accuracy is improved in the case of determining a location by applying the first and second APs 210₁ to 210ₘ and 200₁ to 200ₙ compared to the case of determining a location by using only the second APs 200₁ to 200ₙ.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for measuring a location of a first access point (AP) installed at an unknown position by using at least one terminal that accesses the first AP and a second AP installed at a known position, the method comprising:
receiving at least one first received signal strength intensity value for the first AP;
estimating location information of the terminal by receiving at least one second received signal strength intensity value for the second AP; and
determining a location of the first AP by using matching information when the number of matching information having the at least one first received signal strength intensity value and the location information of the terminal is greater than a predetermined reference number.

2. The method of claim 1, wherein the terminal is one, and the method further comprising, between the estimating and the determining, storing a plurality of location information of terminal by matching to the first received signal strength intensity value, which are estimated by using the at least one first received signal strength intensity values and the at least one second received signal strength intensity values, which are received by the one terminal at a plurality of locations.

3. The method of claim 1, wherein the terminal comprises a plural, the method further comprising, between the estimating of the location information and the determining, storing a plurality of location information of the plurality of terminals by matching to the first received signal strength intensity value, which are estimated by using the at lease one received signal strength intensity values for the first AP received by the plurality of terminals and the at least second received signal strength intensity value for the second AP received by the plurality of terminals.

4. The method of claim 2, wherein the determining of the location information comprises:
determining whether the number of the matching information is greater than the predetermined reference number;
repeating the receiving, the estimating, and the storing when the number of the matching information is smaller than the predetermined reference number; and
estimating the location of the first AP by using a distance measurement value that is converted from the at least one first received signal strength intensity value for the first AP and the location information of the terminal corresponding to the first received signal strength intensity value, to generate location estimation information of the estimated location when the number of the stored matching information items is greater than the predetermined reference number.

5. The method of claim 3, wherein the determining of the location information comprises:
determining whether the number of the stored matching information is greater than the predetermined reference number;
repeating the receiving, the estimating, and the storing when the number of the matching information is smaller than the predetermined reference number; and
estimating the location of the first AP by using a distance measurement value that is converted from the at least one first received signal strength intensity for the first AP and the location information of the terminals to generate location estimation information of the estimated location when the number of the stored matching information is greater than the predetermined reference number.

6. The method of claim 4, wherein the estimating of the location of the first AP comprises:
calculating a covariance of a location estimation error for the first AP by using a least squares method, the location estimation error comprising a determinant formed of an error covariance of a distance between the first AP and the terminal and the distance measurement value;
determining whether the covariance of the location estimation error for the first AP is smaller than a predetermined threshold value;
repeating the receiving, the estimating, the matching and storing, and the determining of the location information when the covariance is not smaller than the predetermined threshold value; and
registering the estimated location information of the first AP to an AP registration database that is formed of AP location information when the covariance is smaller than the predetermined threshold value.

7. The method of claim 5, wherein the estimating of the location of the first AP comprises:
calculating a covariance of a location estimation error for the first AP by using a least squares method, the location estimation error comprising a determinant formed by an error covariance of a distance between the first AP and the terminal and the distance measurement value;
determining whether the covariance of the location estimation error for the first AP is smaller than a predetermined threshold value;
repeating the receiving, the estimating, the matching and storing, and the determining of the location information when the covariance is not smaller than the predetermined threshold value; and
registering the estimated location information of the first AP to an AP registration database that is formed of AP location information when the covariance is smaller than the predetermined threshold value.

8. A location measuring method comprising:
receiving a first received signal strength intensity value from a terminal that has requested location measurement, the first received signal strength intensity value being for a first access point (AP) installed at an unknown position;
checking location information of the first AP, the location information being determined by using location information of the terminal that is estimated by using a second receive signal strength intensity value for a second AP and location information of the second AP; and
calculating weights for the location information of the first AP, the signal strength value being received from the terminal that has requested the location measurement, and an estimated location error of the first AP, and determining a location of the terminal that has requested the location measurement through a weighted least squares method using the weights.

9. The location measuring method of claim 8, wherein, in the determining of the location of the terminal, the weights are calculated by using a ratio of a standard deviation for the location error of the first AP and a distance measurement value that is converted from the first received signal strength intensity value.

10. The location measuring method of claim 9, wherein the determining of the location of the terminal comprises:
calculating a location estimation error for the first AP by using a weight matrix formed by the weights; and
determining the location of the terminal that has requested the location measurement by applying the location estimation error for the first AP.

11. The location measuring method of claim 8, wherein the checking comprises:
checking whether the location information of the first AP is registered;
estimating a location of the first AP when the location information of the first AP is not registered; and
checking the location information of the first AP when the location information of the first AP is registered.

12. The location measuring method of claim 11, wherein the receiving comprises:
receiving received signal strength intensity values for a plurality of APs from the terminal that has requested the location measurement, the received signal strength intensity values of the plurality of APs received from an area surrounding the terminal; and
determining performance of the checking and the determining when the first received signal strength intensity value of the first AP is included in the received signal strength intensity values of the plurality of APs.

13. An apparatus measuring a location of a terminal by using a received signal strength intensity value received from an access point (AP) in a wireless network, the apparatus comprising:
an AP location estimator estimating a location of a first AP by using matching information when the number of matching information is greater than a predetermined reference number, the matching information including location information of the terminal that is estimated by using at least one first received signal strength intensity value of a first access point (AP) installed at an unknown position and at least one second received signal strength intensity value received from a second AP installed at a known position, the first and second received signal strength intensity values being received from the terminal; and
a terminal location calculator calculating weights of the first received signal strength intensity value of the first AP, location information of the first AP, and an estimated location error of the first AP, and determining a location of the terminal that has requested location measurement by using a weighted least squares method when receiving the first received signal strength intensity value from the terminal, the location information of the first AP being estimated by the AP location estimator.

14. The apparatus of claim 13, wherein when a covariance of the location estimation error for the first AP calculated by using a least squares method is smaller than a predetermined threshold value, the AP location estimator registers the location estimation information estimated by the first AP to an AP registration database formed of location information of APs, the location estimation error comprising a determinant formed of an error covariance of a distance between the first AP and the terminal and a distance measurement value obtained based on the first received signal strength intensity value.

15. The apparatus of claim 14, wherein the terminal is one, and the AP location estimator estimates location information of the terminal by using a plurality of location information of the terminal that have been estimated by using the at least one first received signal strength intensity value and at lease second signal strength intensity value, which are received by the one terminal at a plurality of locations.

16. The apparatus of claim 14, wherein the terminal comprises a plural, and the AP location estimator estimates location information of the first AP by using location information of the plurality of terminals and the first received signal strength intensity value, the location information of the plurality of terminals being estimated by using the at least one first received signal strength intensity value received by the plurality of terminals and the at least one second received signal strength intensity value received by the plurality of terminals.

17. The apparatus of claim 13, wherein the terminal location calculator determines a location of the terminal that has requested the location measurer by applying a location estimation error for the first AP that is calculated by using a weight matrix formed of a weight according to a distance between the terminal that has requested the location measurer and the first AP, the weight being calculated by using a ratio between a standard deviation of the location error for the first AP and a distance measurement value that is converted from the first received signal strength intensity value.

18. The apparatus of claim 17, further comprising a signal strength receiver determining whether the first received signal strength intensity value is included in the received signal strength intensity values received from the terminal, wherein the AP location estimator estimates a location of the first AP when estimated location information of the first AP is not registered, and the terminal location calculator determines a location of the terminal that has transmitted the received signal strength intensity values by using the estimated location information when the estimated location information of the first AP is registered.
